(19) United States
(12) Patent Application Publication
(10) Pub. No.: US 2024/0241896 A1
(43) Pub. Date: Jul. 18, 2024

(54) SYSTEMS AND METHODS FOR AUTOMATIC ELECTRONIC DOCUMENT SEARCH AND RECOMMENDATION

(71) Applicant: RELX Inc., Miamisburg, OH (US)

(72) Inventors: Huseyin Sencan, Miamisburg, OH (US); Joseph Hunt, Miamisburg, OH (US)

(73) Assignee: RELX Inc., Miamisburg, OH (US)

(21) Appl. No.: 18/411,700

(22) Filed: Jan. 12, 2024

Related U.S. Application Data
(60) Provisional application No. 63/479,696, filed on Jan. 12, 2023.
(60) Provisional application No. 63/479,699, filed on Jan. 12, 2023.
(60) Provisional application No. 63/479,695, filed on Jan. 12, 2023.

(51) Int. Cl. G06F 16/33; G06F 40/174; G06F 40/40; G06Q 50/18

(52) U.S. Cl. CPC G06F 16/3334; G06F 40/174; G06F 40/40; G06Q 50/18

(57) ABSTRACT

In one embodiment, a method of displaying electronic documents relevant to a matter includes receiving matter information relating to the matter, extracting key phrases from the matter information, generating a query from the key phrases, searching one or more data sources for electronic documents using the query, and displaying, on an electronic display, one or electronic documents relevant to the query.

### CROSS-REFERENCE TO RELATED APPLICATIONS

This application claims priority to U.S. Provisional Application No. 63/479,696 filed on Jan. 12, 2023 and entitled “Automatic Matter Intake Form Suggestion at Time of Matter Request Creation,” U.S. Provisional Application No. 63/479,699 filed on Jan. 12, 2023 and “Automatic Matter Creation from Emails,” and U.S. Provisional Application No. 63/479,695 filed on Jan. 12, 2023 and entitled “Systems and Methods for Recommending the Right Documents for a Given Matter,” all of which are incorporated by reference in their entireties.

### BACKGROUND

A legal matter is any inquiry or dispute regarding the rights or obligations of a party in relation to an agreement. Legal matter management refers to a set of activities that need to be completed by lawyers within a company's legal department or within a law firm to resolve such inquiries. The main components of a legal matter resolution process include information research, document management, and team collaboration. Existing templates and documents from past-related matters are a key part of this process. Lawyers spend a considerable amount of time finding templates and relevant documents for their active matters.

Accordingly, alternative systems and methods for finding relevant templates and documents may be desired.

### BRIEF SUMMARY

In one embodiment, a method of displaying electronic documents relevant to a matter includes receiving matter information relating to the matter, extracting key phrases from the matter information, generating a query from the key phrases, searching one or more data sources for electronic documents using the query, and displaying, on an electronic display, one or electronic documents relevant to the query.

In another embodiment, a system for recommending electronic documents includes one or more processors and a memory storing instructions that, when executed by the processor, configure the one or more processors to receive matter information relating to the matter, extract key phrases from the matter information, generate a query from the key phrases, search one or more data sources for electronic documents using the query, and display, on an electronic display, one or electronic documents relevant to the query.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example system for automatically completing matter intake forms according to one or more embodiments described and illustrated herein.

FIG. 2 illustrates an example graphical user interface for automatically completing matter intake forms according to one or more embodiments described and illustrated herein.

FIG. 3 illustrates an example system for automatically classifying a matter according to one or more embodiments described and illustrated herein.

FIG. 4. illustrates an example system for automatically completing one or more matter intake forms according to one or more embodiments described and illustrated herein.

FIG. 5 illustrates a flowchart of an example method for automatically completing one or more matter intake forms according to one or more embodiments described and illustrated herein.

FIG. 6 illustrates an example system for automatically recommending electronic documents to a user according to one or more embodiments described and illustrated herein.

FIG. 7 illustrates an example user interface for entering matter information according to one or more embodiments described and illustrated herein.

FIG. 8 illustrates an example user interface for presenting recommended electronic documents according to one or more embodiments described and illustrated herein.

FIG. 9 illustrates a flowchart of an example method for recommending one or more electronic documents according to one or more embodiments described and illustrated herein.

FIG. 10 illustrates an example computing system for recommending one or more electronic documents according to one or more embodiments described and illustrated herein.

### DETAILED DESCRIPTION

Embodiments of the present disclosure are directed to systems and methods for automatic document recommendation. Professional personnel, such as lawyers, work on a wide variety of different matters that have different types of documents associated therewith. For example, corporate lawyers have many different types of documents for various matters, such as merger documents, non-disclosure agreements, assignment documents, and the like. On the other hand, litigation lawyers have different types of documents for various matters, such as complaint documents, summary judgement documents, settlement agreements, and the like. A law firm or a legal department of an entity, such as a business, may have template documents for the different types of matters that a lawyer may use depending on the nature and facts of the matter. Law firms and legal departments also have historical electronic documents prepared for past matters that may be beneficial to lawyers working on current matters.

Embodiments of the present disclosure automatically suggest internal electronic documents based on matter information describing the matter a person is working on. As described in more detail below, the matter information may be provided in a matter intake form, or inputted into a user interface that solicits the matter information from a user. Electronic documents relevant to the matter information are automatically surfaced and presented to the user in a user interface.

In some embodiments, the process of generating a matter intake form is automatic. For example, embodiments of the present disclosure provide for automatically classifying a matter type and automatically completing one or more matter intake forms based on the matter type upon matter intake by extracting field data from input data. Generally, embodiments may include receiving input data regarding a new matter, and automatically classifying the new matter into a matter classification based on the input data. One or more matter intake forms are then selected based on the matter classification. Field data is then automatically extracted from the input data and populated into relevant fields of the one or more matter intake forms. The matter intake forms can then be used to automatically recommend electronic documents to the user. In other embodiments, the matter intake forms are manually completed.

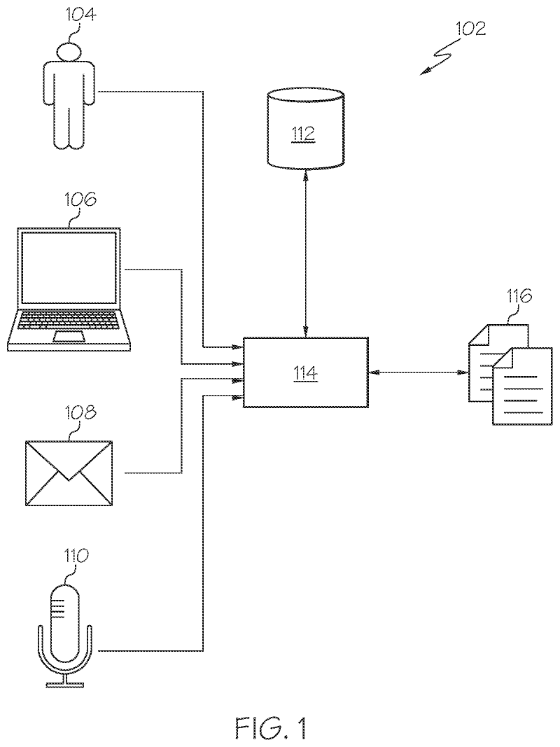

Referring now to FIG. 1, an example system 102 for automatically filling out matter intake forms 116 is schematically illustrated. It should be understood that in some embodiments, matter intake forms are not automatically recommended and/or completed. It should also be understood that embodiments are not limited to the configuration of FIG. 1 and that more or fewer elements may be provided.

Generally, the system 102 includes various input data sources 104-110 that provide input data to a matter intake form generator 114. As described in more detail below, the matter intake form generator 114 includes one or more trained models to both detect the matter classification and automatically complete one or more matter intake forms 116 based on the input data.

The input data sources may take on a variety of different forms. In the illustrated example, the input data sources include a chat bot 104, a text input 106, an electronic file input 108, and a spoken input 110. These various input data sources provide input data relating to a new matter that has been received into an organization, such as a new legal matter. The input data is used to classify the matter and complete one more matter intake forms 116 relating to the matter. The user may use the one or more input data source to provide information relating to the matter.

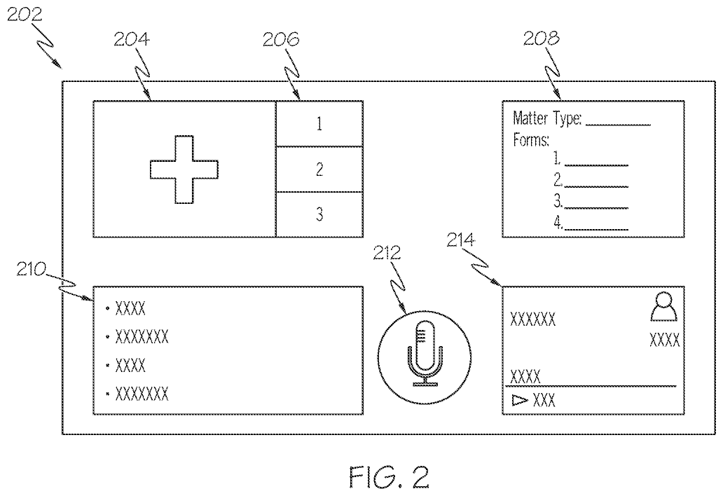

The input data sources 104-110 may be provided in a computer software application that is accessible to the user. FIG. 2 illustrates an example user interface 202 of a software application that is configured to complete matter intake forms 116. The user interface 202 may be a component of a stand-alone software application product, or it may be a plug-in feature of a larger software application tailored to a particular field (e.g., a legal research software program).

The example user interface 202 includes a chat bot interface 214 that provides a chat bot 104 functionality for the user to provide input data regarding the particular matter. The chat bot interface 214 may utilize any known or yet-to-be-developed chat bot model for prompting questions and obtaining information. The chat bot model may be trained on various different matters and to produce relevant questions and statements to elicit the input data from the user. The chat bot 104 may be further trained on historic data, such as previous queries.

The user may ask the chat bot various queries pertaining to a matter, such as legal queries of a legal matter. In the legal context, if the user's query can have its resolution automated by referencing internal legal policy documentation, the user is provided with search results for the given query. When the chat bot identifies that the user is indicating a need to submit a legal request (i.e., user's intended result cannot be automated), it will respond and ask the user to describe the needed legal task.

For example, if the user asks a question regarding elements of submitting a contract request, for example, a non-disclosure agreement, the chat bot 104 may ask for description of what the user needs. The chat bot 104 then supplies an appropriate matter intake form for the user. In some embodiments, the chat bot 104 asks questions of the user relating to information that is still needed to include in a matter intake form.

The user interface 202 also include a file import interface 204 for the user to import electronic files relevant to the new matter. Thus, the file import interface 204 provides an interface for the electronic file input 108 illustrated in FIG. 1. The user may drag-and-drop relevant files into the file import interface 204, or use another means to import the electronic files. Electronic files that are inputted are then listed in an imported files list 206 for review by the user. The user can take various actions regarding the files in the imported files list 206, including opening files, deleting the files, prioritizing the files (e.g., moving them up and down in the list).

As a non-limiting example, one of the electronic files may be an email. The email may be from a client describing a new matter as one example. As another example, the email may be from an organization member to an assistant or the matter intake department that describes the new matter in natural language. For example, the email may include language such as “We received a new patent infringement law suit from Client X where they are being sued by Company Y for alleged infringement of Patent No. X0,135,126. The patent is for a dog chew toy . . . ” As described in more detail below, the matter intake form generator 114 receives the email and uses its text as input data to classify the matter and complete one or more matter intake forms.

Other electronic documents may also be imported using the file import interface 204, such as a legal complaint, other legal documents, company profiles, and the like. These electronic documents may also be used as input data by the matter intake form generator 114.

The user interface 202 of FIG. 2 also includes a text box 210 that is provided for a user to add free-form text regarding the new matter. The user may type in natural language sentences, fragments, words, and the like into the text box 210. No particular formatting is needed. The text box 210 may be used in lieu of the chat bot 104 if the user is familiar with what type of information is needed for the matter intake form generator 114. For example, the user may type in “client: company X; matter: wrongful death; plaintiff: company Y; new client: yes; field: nautical;” and the like into the text box 210. The matter intake form generator 114 receives this data and may use it to classify the matter and complete one or more matter intake forms as described in more detail below.

A microphone button 212 is provided to give the user the ability to use spoken language to provide input data into the system. When the user selects the microphone button 212, the computer software program accesses a microphone of the computer (e.g., desktop computer, laptop computer, smart phone, tablet, and the like). The user can then speak into the microphone (not shown) to describe the new matter that has come in. The user can speak in natural language sentences, or in fragments such as the wrongful death example above, to describe the new matter. The system may include a speech-to-text algorithm to convert the spoken language into text that is then used by the matter intake form generator 114 to classify the new matter and complete the one or more matter intake forms 116.

Referring again to FIG. 1 and as described in more detail below, the matter intake form generator 114 receives input data from one or more input data sources 104-110 and uses it to classify the matter and to complete one or more matter intake forms 116. The matter intake form generator 114 accesses a matter data storage 112 for data relevant to performing its functions, such as historical data, matter data, and any other data needed.

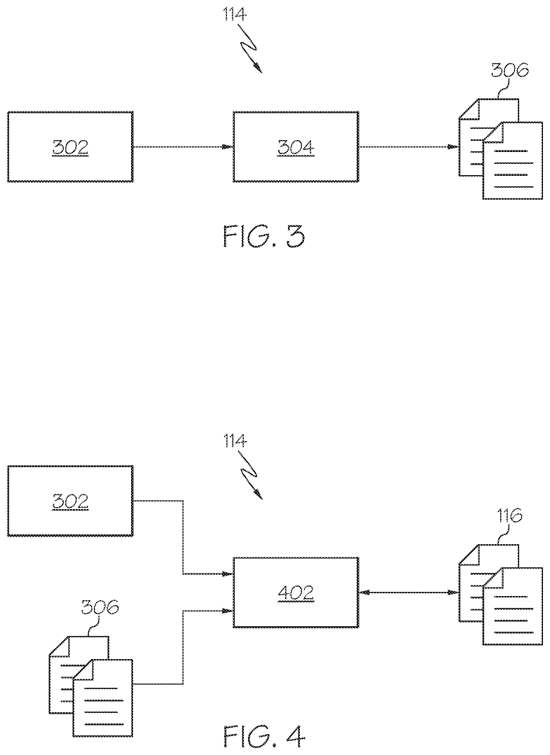

Referring now to FIG. 3, a portion of the system 102 for classifying the matter is illustrated. The matter intake form generator 114 may include a matter classifier 304, which may be a trained classifier that is trained to receive the input data 302 and output a matter classification (e.g., merger, patent infringement, real estate closing, etc.). The matter classifier 304 may be a supervised classifier such as, without limitation, a support vector machine, K-nearest neighbors, Naive Bayes, and logistic regression. The trained classifier is trained to output a matter classification based on input data describing the matter. Embodiments are not limited by the type or number of classifications.

Using the wrongful death example from above, the user may have submitted an email from the client describing the nature of the law suit into the file import interface 204, and also may have inputted various facts regarding the matter into the text box 210, or provided spoken dialogue using the microphone button 212. The trained classifier receives this input data 302 and outputs one or more matter classifications. In this example, the matter is “litigation.” Sub-matters classifications may also be generated, such as “wrongful death,” or a specific matter classifications may be generated, such as “litigation—wrongful death.”

The one or more matter classifications that are outputted by the matter classifier 304 may be displayed in a suggested forms region 208, as shown in FIG. 2. In this way, the user can be confident that the system properly classified the matter. If any changes need to be made, the user may make a change to the matter classification in the suggested forms region 208.

The matter classifier 304 outputs one or more blank matter intake form 306 as shown in FIG. 3. The one or more blank matter intake forms 306 may be listed in the suggested forms region 208. A user can select a listed matter intake form from the suggested forms region 208 to open it, save it, or otherwise interact with it. The user may opt to fill out the one or more matter intake form manually or in some embodiments automatically. There may be a user interface element that the user may select to cause a selected matter intake form to be automatically filled out using field data extracted from the input data.

Referring now to FIG. 4, a portion of the system for automatically filling in (i.e., completing) one or more blank matter intake forms 306 is illustrated. The matter intake form generator 114 includes a field data extractor 402 that is operable to extract field data from the input data and populate the extracted field data into the appropriate fields of the one or more blank matter intake forms 306. In some embodiments, the field data extractor 402 extracts data from the input data 302 by searching its contents for text matching an intake field's predefined formula, then imports that data into the matter type's associated intake form. Each field of the blank matter intake form 306 has a data formula defined for data extraction (for example, a Contract matter type has the intake form field “contract value”. This field's data formula defines the appropriate contents to be of the formats “$xxx,xxx {x=numeric variable}”, “xx,xxx$”, “yyyyyy-yyyyyyyy {y=free text variable} dollars”, etc. Text in the input data 302 matching those criteria is assigned a data type label for extraction).

In other embodiments, the field data extractor 402 comprises a large language model that is operable to receive the input data 302 and the one or more blank matter intake form s 306 or a list of the fields of the one or more blank matter intake forms 306. The system provides a prompt to the large language model for it to extract the fields from the one or more blank matter intake forms 306, and to find field data within the input data 302 that matches the fields. In embodiments where only the fields are provided as input to the large language model rather than the blank matter intake forms 306 themselves, the prompt may be configured to ask the large language model to find the field data within the input data 302 that matches the provided fields. The output of the large language model may be field-field data pairs. The field data extractor 402 may further include a script that takes the field-field data pairs and populates the fields of the one or more blank matter intake forms 306 with the field data extracted from the input data 302.

The end result is one or more populated matter intake forms 116. These forms can be used for downstream purposes, such as, without limitation, providing legal representation, performing medical care based on the data in the matter intake forms 116, creating a work (e.g., a website, an advertisement, an artwork), generating software code (e.g., generating a software program per requirements of the matter intake form), building a structure (e.g., building a house or renovating a building based on requirements of the matter intake form). In some embodiments, the matter intake forms are computer readable and may be automatically transmitted to a machine to autonomously perform an automated physical task, such as an autonomous vehicle that autonomously navigates an environment.

For example, once a matter intake form is completed, the system then submits that completed matter intake form as a matter within the workflow tool for review and assignment. A legal matter may be any inquiry or dispute regarding the rights or obligations of a party in relation to an agreement. In embodiments, legal matter management may refer to a set of activities to be completed a company's legal department. In other embodiments, the system may be used to generate matter forms for any business group and is not limited to legal matters. For example, the system or method may extract data from an email, classify the data for a matter and populate a matter intake form.

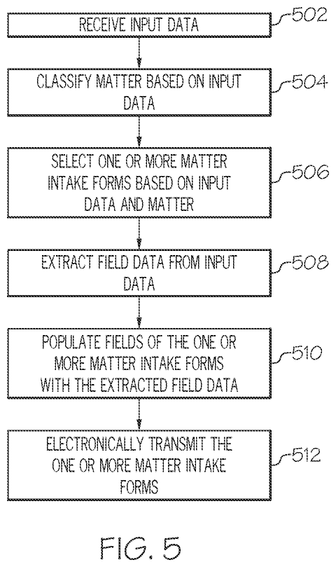

Referring now to FIG. 5, a method for completing one or more matter intake forms is illustrated. At block 502, input data related to a new matter is received by the system. The input data may be generated by any method, such as natural speech, use of a chat bot, imported electronic files, and free text. Next, at block 504 a matter is classified using the input data and a matter classifier of a matter intake form generator 114. From the classified matter, one or more relevant matter intake forms are selected at block 506. These forms may be selected from a repository of forms stored in a data storage device, for example.

At block 508 field data is extracted from the input data. The field data is data that is relevant to fields of the one or more matter intake forms that are selected at block 506. In the legal context, field data may include client name, adverse party NAISC codes, amount at controversy, and the like. A field data extractor is configured to extract the field data from the input that is provided by the user. Next, at block 510 the selected one or more matter intake forms are populated with the field data that was extracted at block 508. Now the system has created populated matter intake forms that are ready for downstream processes, such as transmitting the one or more matter intake forms to desired persons/entities at block 512.

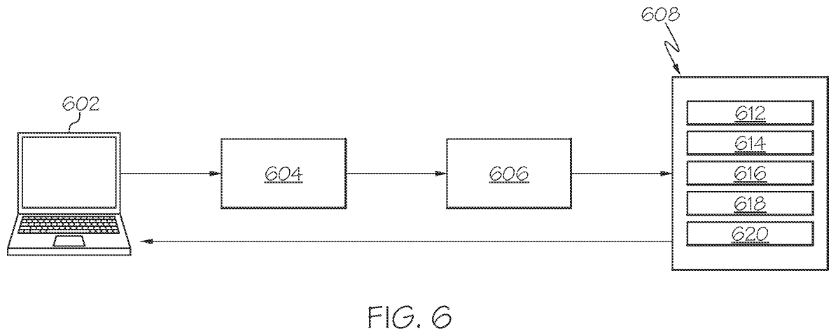

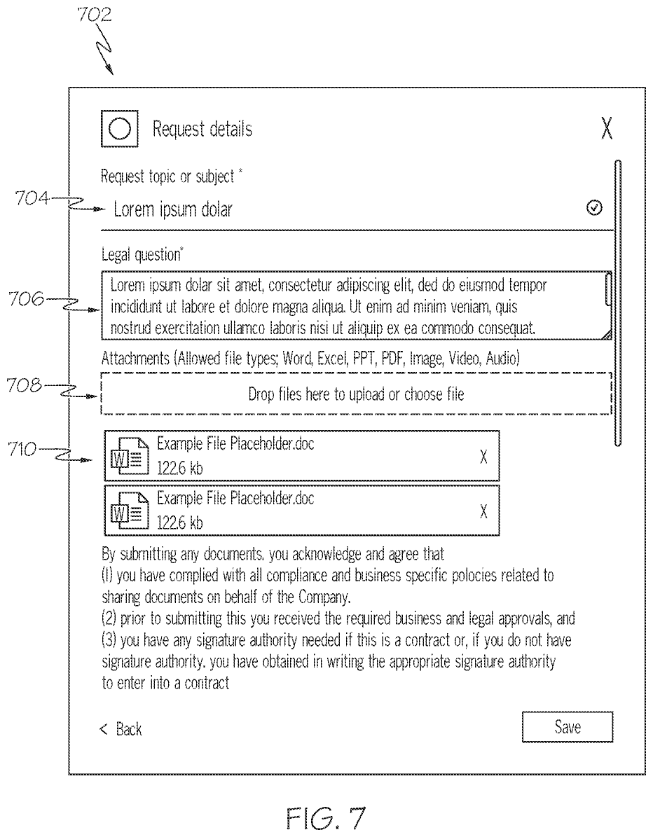

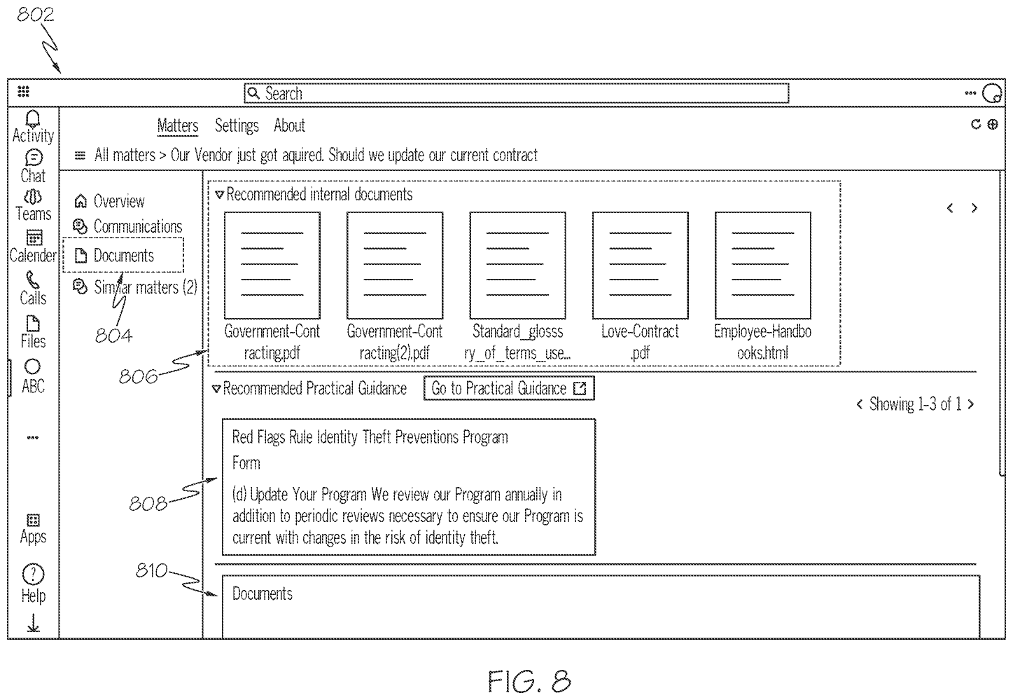

Referring now to FIG. 6, a system for automatically recommending internal electronic documents to a user is schematically illustrated. A user device 602 provides matter information to a data extractor 604. The matter information may be one or more matter intake forms that are generated automatically or manually. The user device 602 may also provide a user interface 702 (FIG. 7) that prompts the user to enter matter information to have electronic documents automatically recommended. The information that is provided may be a title for the matter, as well as a description, for example. The description can include any information that describes the particular matter. In the legal context, the description can be in the form of a legal question, facts surrounding the legal matter, the parties, the jurisdiction, and the like. The description can be written in natural language. In some embodiments, the user may upload documents relating to the matter, such as documents containing facts, summaries, and the like.

FIG. 7 illustrates an example user interface 702 to be displayed by an electronic device. The non-limiting user interface 702 includes a topic text field 704 for the user to enter a topic of a particular matter, which may be a title of the matter, or simply the type of matter, such as “contract dispute” or “negligence action.”

A description text field 706 includes a place for the user to type or otherwise enter a description of the matter, such as a legal question, fact, jurisdiction, and the like. A file upload region 708 may be provided to enable the user to upload documents that are relevant to the matter. For example, the user may drag and drop electronic file icons into the file upload region 708 to select them for upload. Files that have been selected for upload may be displayed in a file upload list 710 for the user to review and potentially remove selected files if needed. It is noted that the matter information may also be generated using the various methods illustrated by the user interface 202 of FIG. 2 (e.g., spoken words).

Referring once again to FIG. 6, the matter information is provided to the data extractor 604. The data extractor 604 is operable to extract key phrases from the matter information. Key phrases are any word or phrase that is relevant to matter and may be useful for generating a query to find relevant electronic documents to recommend to the user. The key phrases may be extracted from the matter intake form, a matter title, a matter description, and/or uploaded files of the matter information.

Any known or yet-to-be-developed method for extracting key phrases from the matter information may be utilized. As a non-limiting example, the data extractor 604 incorporates a large language model that is prompted to return key phrases from the matter information that is inputted into the data extractor 604. As another non-limiting example, the data extractor 604 incorporates a natural language processing model, such as Azure AI Language offered by Microsoft Corporation of Redmond, WA to extract the key phrases.

The key phrases extracted by the data extractor 604 are provided to the query engine 606 that is operable to automatically generate one or more queries from the key phrases and to search data sources 608 for relevant internal documents. As a non-limiting example, the data sources 606 may be provided in a Microsoft SharePoint folders or sites, such as folder 612, folder 614, folder 616, folder 618, folder 620, which each folder (or site) containing different information. For example, folder 612 may include templates, and folder 612 may include completed documents. As a non-limiting example, the query engine may perform a graph search over the data sources 606, such as a graph search implemented by the Microsoft Graph API offered by Microsoft.

The query engine may be operable to perform a lexical search over the data sources 608, whereby the key phrases are compared against the electronic documents stored in the data sources 608. In some embodiments, both the matter information and the electronic documents stored in the data sources 606 are classified according to a classification scheme. A document classifier classifies a document D that a user X is working on (e.g., the matter information) with a classification be type T. Then in the document recommendation, the query engine 606 would boost all documents of type T. In some embodiments, the system uses topic classification to identify topics in a document D. For example, let the topics be t1, t2, and so on, such that in the document recommendation, the system boosts all documents that have the same/similar topics to t1, t2. In some embodiments, the system uses recommender system algorithms on user-document edit history to recommend documents. The system may build a knowledge graph with document, people, matter, and the like, and uses graph algorithms to recommend documents.

As such, the documentation recommendation system may use several different methods and/or combinations of different methods to provide document recommendation. As a non-limiting example, an example legal matter may be “Negotiated Acquisition of XYZ Corp”. The embodiments described herein may suggest documents that provide guidelines such as “Critical Boilerplate in Acquisition Agreements.docx” and/or documents that are templates such as “Cross-Border Confidentiality Agreement (Company Acquisition).pdf” and “Sample Acquisition Agreement.html”. As such, the suggested documents are not limited to a specific format and, as shown in this example, may include, without limitation, .html, .docx, .pdf, and the like. Documents are not limited and may include webpages and other internet sites, documents saved in a plurality of different formats, and/or images and the like.

As shown in FIG. 6, recommended documents are then returned to the user. FIG. 8 illustrates an example user interface 802 for presenting recommended documents to a user. A Documents icon 804 is provided that, when selected by a user, causes recommended internal documents to be displayed in the Recommended documents region 806. The user may select one or more of the documents in the Recommended documents region 806 to open them in another program (e.g., a word processing program), or preview them in a Document region 801. In addition to internal documents, the example, user interface 802 includes a Recommended practical guidance region 808 which provides relevant internal or external information, such as treatises, secondary sources, general information regarding the matter type, and the like.

The user may use these recommended documents and practical guidance in furtherance of completing the matter.

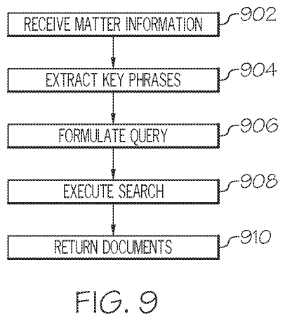

FIG. 9 illustrates a flowchart of an example method for recommending electronic documents relevant to a matter. At block 902, matter information is received by the system. The matter information may be a matter intake form, uploaded documents, information inputted into a user interface, or any other information relevant to the matter. At block 904 key phrases are extracted from the matter information. The key phrases are provided as input to a query engine that formulates a query at block 906, and executes a search of data sources using the key phrases at block 908. At block 910 the recommended documents that were found during the search are returned to the user for use.

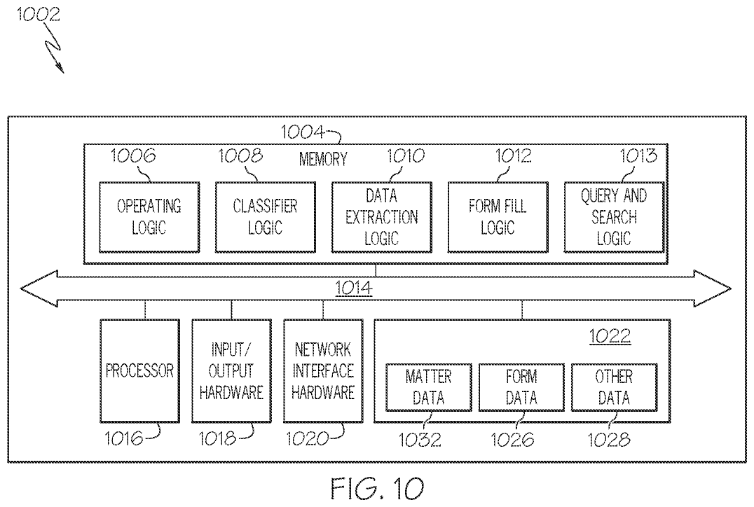

Embodiments of the present disclosure may be implemented by a computing device, and may be embodied as computer-readable instructions stored on a non-transitory memory device. Referring now to FIG. 10, an example system for automatically recommending electronic documents as a computing device 1002 is schematically illustrated. The example computing device 1002 provides a system for automatically recommending electronic documents, and/or a non-transitory computer usable medium having computer readable program code for automatically recommending electronic documents embodied as hardware, software, and/or firmware, according to embodiments shown and described herein. While in some embodiments, the computing device 1002 may be configured as a general purpose computer with the requisite hardware, software, and/or firmware, in some embodiments, the computing device 1002 may be configured as a special purpose computer designed specifically for performing the functionality described herein. It should be understood that the software, hardware, and/or firmware components depicted in FIG. 10 may also be provided in other computing devices external to the computing device 1002 (e.g., data storage devices, remote server computing devices, and the like).

As also illustrated in FIG. 10, the computing device 1002 (or other additional computing devices) may include a processor 1016, input/output hardware 1018, network interface hardware 1020, a data storage component 1022 (which may store matter data 1024 (e.g., data relating to matter classifications, previous matter data, and the like), form data 1026 (e.g., data relating to the various forms), and any other data 1028 for performing the functionalities described herein), and a non-transitory memory component 1004. The memory component 1004 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components.

Additionally, the memory component 1004 may be configured to store operating logic 1006, classifier 1008 for automatically classifying input data of a new matter into a matter classification, data extraction logic 1010 for extracting field data from the input data, form fill logic 1012 for filling one or more matter forms with the extracted field data, and query search logic for extracting key phrases and for generating and executing queries as described herein (each of which may be embodied as computer readable program code, firmware, or hardware, as an example). It should be understood that the data storage component 1022 may reside local to and/or remote from the computing device 1002, and may be configured to store one or more pieces of data for access by the computing device 1002 and/or other components.

A local interface 1014 is also included in FIG. 10 and may be implemented as a bus or other interface to facilitate communication among the components of the computing device 1002.

The processor 1016 may include any processing component configured to receive and execute computer readable code instructions (such as from the data storage component 1022 and/or memory component 1004). The input/output hardware 1018 may include virtual reality headset, graphics display device, keyboard, mouse, printer, camera, microphone, speaker, touch-screen, and/or other device for receiving, sending, and/or presenting data. The network interface hardware 1020 may include any wired or wireless networking hardware, such as a modem, LAN port, wireless fidelity (Wi-Fi) card, WiMax card, mobile communications hardware, and/or other hardware for communicating with other networks and/or devices.

Included in the memory component 1004 may be the operating logic 1006, classifier logic 1008, data extraction logic 1010, form fill logic 1012, and query and search logic 1013. The operating logic 1006 may include an operating system and/or other software for managing components of the computing device 1002. Similarly, the classifier logic 1008 may reside in the memory component 1004 and may be configured to automatically classify the matter of input data into a matter classification. The data extraction logic 1010 also may reside in the memory component 1004 and may be configured to automatically extract relevant field data from the input data based on the matter classification. The form fill logic 1012 includes logic to automatically fill one or more matter intake forms with the extracted field data. The query and search logic 1013 includes logic to extract key phrases from matter information, generate one or more queries from the key phrases, and search data sources for electronic documents using the one or more queries. It should be understood that embodiments that do not utilize the automatic matter classification and/or automatic matter intake form completion features will not have the classifier logic 1008, the data extraction logic 1010 and the form fill logic 1012.

The components illustrated in FIG. 10 are merely exemplary and are not intended to limit the scope of this disclosure. More specifically, while the components in FIG. 10 are illustrated as residing within the computing device 1002, this is a non-limiting example. In some embodiments, one or more of the components may reside external to the computing device 1002.

It should now be understood that embodiments of the present disclosure are directed to systems and methods for automatically recommending electronic documents to a user based on matter information. When a user is starting a new matter, matter information, such as a matter intake form, a description of the matter, and/or uploaded documents, is used to find internal documents that may be helpful to a user. Particularly, in the legal field, templates and previously completed documents may be very helpful to a user to efficiently complete various tasks in completion of the legal matter.

Key phrases are extracted from the matter information and are used as one or more queries that search against internal data sources, such as by a lexical search. The electronic documents that are found are then provided to the user as recommended documents in a user interface. The user may they apply the recommended documents in completion of the matter.

Some embodiments provide for automatically classifying new matters (e.g., legal matters) into a matter classification, and automatically filling one or more matter intake forms with relevant data extracted from input data describing a new matter. The input data can take a variety of forms, such as electronic documents (e.g., emails), spoken language, free text, and interactions with a chat bot. Field data is automatically extracted from the input data by a model, such as a large language model, and used to populated the one or more matter intake forms. The process saves time and resources to produce the matter intake forms over traditional methods.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A method of displaying electronic documents relevant to a matter, the method comprising:
receiving matter information relating to the matter;
extracting key phrases from the matter information;
generating a query from the key phrases;
searching one or more data sources for electronic documents using the query; and
displaying, on an electronic display, one or more electronic documents relevant to the query.

2. The method of claim 1, wherein the matter information is provided in a matter intake form.

3. The method of claim 2, wherein the matter intake form is automatically generated by:
receiving input data from one or more sources, the input data relating to a matter;
classifying, using a trained model, a matter classification based at least in part on the input data;
selecting one or more matter forms based on the matter classification;
automatically extracting field data from the input data; and
automatically populating fields of the one or more matter forms with the extracted field data.

4. The method of claim 3, wherein the trained model is a classifier model.

5. The method of claim 3, wherein the trained model is a large language model.

6. The method of claim 1, further comprising converting the key phrases into one or more vectors, and the searching the one or more data sources comprises finding similarity between the one or more vectors of the key phrases with vectors of the electronic documents stored in the one or more data sources.

7. The method of claim 1, further comprising classifying the matter information into one or more classifications, wherein the query is based at least in part on the one or more classifications.

8. The method of claim 1, wherein searching the one or more electronic documents comprises performing a graph search.

9. The method of claim 1, further comprising displaying, on the electronic display, a user interface comprising a matter title field and a matter description field both operable to receive the matter information from a user.

10. The method of claim 1, further comprising retrieving historical user data, wherein the query is based at least in part on the historical user data.

11. A system for recommending electronic documents comprises:
one or more processors; and
a memory storing instructions that, when executed by the processor, configure the one or more processors to:
receive matter information relating to the matter;
extract key phrases from the matter information;
generate a query from the key phrases;
search one or more data sources for electronic documents using the query; and
display, on an electronic display, one or more electronic documents relevant to the query.

12. The system of claim 11, wherein the matter information is provided in a matter intake form.

13. The system of claim 12, wherein the matter intake form is automatically generated by:
receiving input data from one or more sources, the input data relating to a matter;
classifying, using a trained model, a matter classification based at least in part on the input data;
selecting one or more matter forms based on the matter classification;
automatically extracting field data from the input data; and
automatically populating fields of the one or more matter forms with the extracted field data.

14. The system of claim 13, wherein the trained model is a classifier model.

15. The system of claim 13, wherein the trained model is a large language model.

16. The system of claim 11, wherein the instructions further configure the one or more processors to convert the key phrases into one or more vectors, and the searching the one or more data sources comprises finding similarity between the one or more vectors of the key phrases with vectors of the electronic documents stored in the one or more data sources.

17. The system of claim 11, wherein the instructions further configure the one or more processors to classify the matter information into one or more classifications, wherein the query is based at least in part on the one or more classifications.

18. The system of claim 11, wherein searching the one or more electronic documents comprises perform a graph search.

19. The system of claim 11, wherein the instructions further configure the one or more processors to display, on the electronic display, a user interface comprising a matter title field and a matter description field both operable to receive the matter information from a user.

20. The system of claim 11, wherein the instructions further configure the one or more processors to retrieve historical user data, wherein the query is based at least in part on the historical user data.
